(19) United States
(12) Patent Application Publication
(10) Pub. No.: US 2025/0055512 A1
(43) Pub. Date: Feb. 13, 2025

(54) PRECODING METHOD AND DEVICE, SOTRAGE MEDIUM, AND APPARATUS

(71) Applicant: BEIJING XIAOMI MOBILE SOFTWARE CO., LTD., Beijing (CN)

(72) Inventors: Liangang CHI, Beijing (CN); Gaoming DUAN, Beijing (CN)

(73) Assignee: BEIJING XIAOMI MOBILE SOFTWARE CO., LTD., Beijing (CN)

(21) Appl. No.: 18/720,369

(22) PCT Filed: Dec. 14, 2021
(86) PCT No.: PCT/CN2021/138019

§ 371 Date: Jun. 14, 2024

(51) Int. Cl. H04B 7/0456; H04B 7/06

(52) U.S. Cl. CPC H04B 7/0456; H04B 7/0634

(57) ABSTRACT

The present disclosure relates to the technical field of communications, and provides a precoding method and device/storage medium/apparatus. The method comprises: transmitting a reference signal for channel estimation to a receiving end; receiving precoding information sent by the receiving end, the precoding information comprising at least one of at least one modality combination index, a precoding matrix indicator (PMI), and the number of modalities, and the number of modalities being used for indicating the maximum number of orbital angular momentum (OAM) modalities that can be transmitted under the current channel condition; determining transmission modality information on the basis of the precoding information and transmitting a precoding weight vector; and indicating the transmission modality information to the receiving end.

### CROSS-REFERENCE TO RELATED APPLICATION

The application is the U.S. National Stage of International Application No. PCT/CN2021/138019, filed on Dec. 14, 2021, the entire content of which is incorporated herein by reference for all purposes.

### TECHNICAL FIELD

The present disclosure relates to the technical field of communication, and in particular, to a precoding method and device/storage medium/apparatus.

### BACKGROUND

In order to solve the problem of shortage of spectrum resources, Uniform circular array (UCA) is usually used to establish an Orbital angular momentum (OAM) communication system. In the UCA-based OAM communication system, the non-aligned OAM communication system may cause inter-mode interference, thus the transmitting end usually needs to perform precoding to perform beam steering on the transmitted OAM beam to reduce the inter-mode interference at the receiving end, and to increase the system channel capacity.

In the related art, the UCA-based codebook is usually designed by using the principal eigenvector of the channel matrix and the Hadamard matrix, the departure angle of the OAM beam transmitted by the transmitting end is described by the azimuth angle and the depression angle, the azimuth angle and the depression angle are quantified to generate the UCA-based codebook, and the UCA-based codebook is used for precoding.

### SUMMARY

The precoding method provided by an embodiment according to an aspect of the present disclosure is applied to a network side device, and includes:
sending a reference signal for channel estimation to a receiving end;
receiving precoding information sent by the receiving end, where the precoding information includes at least one of at least one mode combination index, a precoding matrix index (PMI), or a mode number; the mode number is used to indicate: a maximum number of an orbital angular momentum (OAM) mode that can be transmitted under a current channel condition;
determining transmission mode information and a transmitting precoding weight vector based on the precoding information; and
indicating the transmission mode information to the receiving end.

The precoding method provided by an embodiment according to an aspect of the present disclosure is applied to a UE, and includes:
receiving a reference signal for channel estimation sent by a transmitting end, and performing a channel estimation based on the reference signal to obtain channel information;
determining precoding information based on the channel information, where the precoding information includes at least one of at least one mode combination index, a PMI, or a mode number; the mode number is used to indicate: a maximum number of an OAM mode that can be transmitted under a current channel condition;
sending the precoding information to the transmitting end; and
receiving transmission mode information indicated by the transmitting end.

A precoding apparatus provided by another embodiment according to an aspect of the present disclosure includes:
a sending module, configured to send a reference signal for channel estimation to a receiving end;
a receiving module, configured to receive precoding information sent by the receiving end, where the precoding information includes at least one of at least one mode combination index, a precoding matrix index (PMI), or a mode number; the mode number is used to indicate: a maximum number of an orbital angular momentum (OAM) mode that can be transmitted under a current channel condition;
a determining module, configured to determine transmission mode information and a transmitting precoding weight vector based on the precoding information; and
an indication module, configured to indicate the transmission mode information to the receiving end.

A precoding apparatus provided by another embodiment according to an aspect of the present disclosure includes:
a receiving module, configured to receive a reference signal for channel estimation sent by a transmitting end, and perform a channel estimation based on the reference signal to obtain channel information;
a determining module, configured to determine precoding information based on the channel information, where the precoding information includes at least one of at least one mode combination index, a PMI, or a mode number; the mode number is used to indicate: a maximum number of an orbital angular momentum (OAM) mode that can be transmitted under a current channel condition;
a sending module, configured to send the precoding information to the transmitting end; and
a receiving module, configured to receive transmission mode information indicated by the transmitting end.

An embodiment in yet another aspect of the present disclosure provides a communication apparatus, the apparatus includes a processor and a memory, a computer program is stored in the memory, and the processor executes the computer program stored in the memory, so that the apparatus performs the method provided in the embodiments of the above aspect.

An embodiment in yet another aspect of the present disclosure provides a communication apparatus, the apparatus includes a processor and a memory, a computer program is stored in the memory, and the processor executes the computer program stored in the memory, so that the apparatus performs the method provided in the embodiments of the above another aspect.

A communication apparatus provided by an embodiment of another aspect of the present disclosure includes: a processor and an interface circuit;
the interface circuit is used to receive code instructions and transmit them to the processor;
the processor is configured to run the code instructions to perform the method provided in the embodiments of the above aspect.

A communication apparatus provided by an embodiment of another aspect of the present disclosure includes: a processor and an interface circuit;
the interface circuit is used to receive code instructions and transmit them to the processor;
the processor is configured to run the code instructions to perform the method provided in the embodiments of the above another aspect.

The computer-readable storage medium provided by an embodiment of another aspect of the present disclosure is used to store instructions, and when the instructions are executed, the method provided by the embodiments of the above aspect is implemented.

The computer-readable storage medium provided by an embodiment of another aspect of the present disclosure is used to store instructions, and when the instructions are executed, the method provided by the embodiments of the above another aspect is implemented.

To sum up, in the precoding method and device/storage medium/apparatus provided by the embodiments of the present disclosure, the transmitting end may send the reference signal for channel estimation to the receiving end, and then the transmitting end may receive the precoding information sent by the receiving end, and determine the transmission mode information and the transmitting precoding weight vector based on the precoding information, and finally, may indicate the transmission mode information to the receiving end. It can be seen that the precoding method proposed in the embodiments of the present disclosure can effectively solve the problems of received signal energy loss and inter-mode interference in a scenario where the transmitting end and the receiving end are not aligned. Moreover, the embodiments of the present disclosure are based on a digital precoding design scheme, which has low feedback overhead and high quantization accuracy.

### BRIEF DESCRIPTION OF THE DRAWINGS

The above and/or additional aspects and advantages of the present disclosure will become apparent and understandable from the following description of the embodiments in conjunction with the accompanying drawings, where:

FIG. 1 is a schematic flowchart of a precoding method provided by an embodiment of the present disclosure;

FIG. 2 is a schematic flowchart of a precoding method provided by another embodiment of the present disclosure;

FIG. 3 is a schematic flowchart of a precoding method provided by another embodiment of the present disclosure;

FIG. 4 is a schematic flowchart of a precoding method provided by another embodiment of the present disclosure;

FIG. 5 is a schematic flowchart of a precoding method provided by another embodiment of the present disclosure;

FIG. 6 is a schematic flowchart of a precoding method provided by another embodiment of the present disclosure;

FIG. 7 is a schematic structural diagram of a precoding apparatus provided by an embodiment of the present disclosure;

FIG. 8 is a schematic structural diagram of a precoding apparatus provided by another embodiment of the present disclosure;

FIG. 9 is a block diagram of a user device provided by an embodiment of the present disclosure; and

FIG. 10 is a block diagram of a network side device provided by an embodiment of the present disclosure.

### DETAILED DESCRIPTION

Reference will now be made in detail to the exemplary embodiments, examples of which are illustrated in the accompanying drawings. When the following description refers to the accompanying drawings, the same numerals in different drawings refer to the same or similar elements unless otherwise indicated. The implementations described in the following exemplary embodiments do not represent all implementations consistent with the embodiments of the present disclosure. Rather, they are merely examples of apparatuses and methods consistent with some aspects of the embodiments of the present disclosure as recited in the appended claims.

The terms used in the embodiments of the present disclosure are for the purpose of describing specific embodiments only, and are not intended to limit the embodiments of the present disclosure. As used in the examples of the present disclosure and the appended claims, the singular forms “a/an” and “the” are also intended to include the plural unless the context clearly dictates otherwise. It should also be understood that the term “and/or” as used herein refers to and includes any or all possible combinations of one or more of the associated listed items.

It should be understood that although the embodiments of the present disclosure may use the terms first, second, third, etc. to describe various information, the information should not be limited to these terms. These terms are only used to distinguish information of the same type from one another. For example, without departing from the scope of the embodiments of the present disclosure, first information may also be called second information, and similarly, second information may also be called first information. Depending on the context, the words “if” and “in case” as used herein may be interpreted as “when” or “while” or “in response to a determination.”

The precoding method, apparatus, user device, network side device, and storage medium provided by the embodiments of the present disclosure are described in detail below with reference to the accompanying drawings.

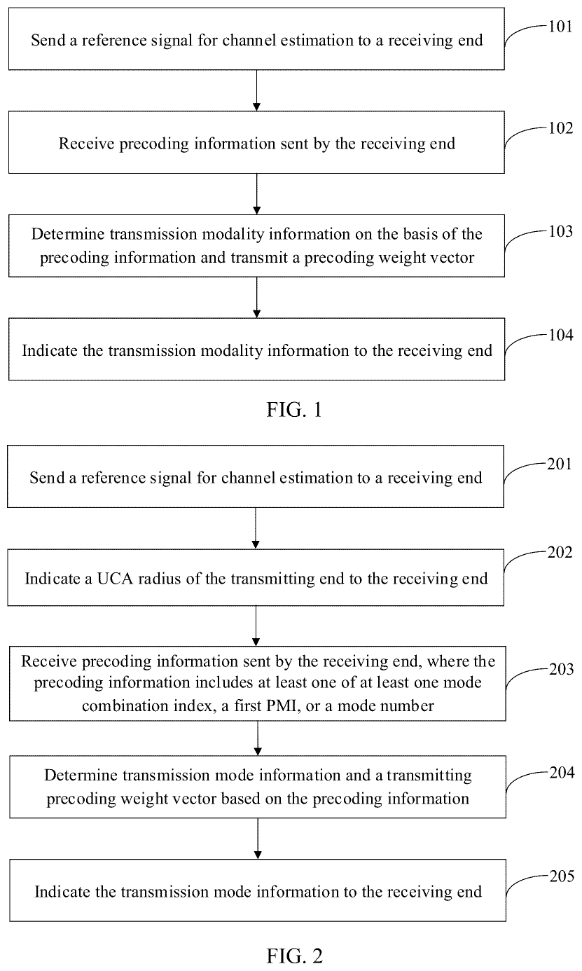

FIG. 1 is a schematic flowchart of a precoding method provided by an embodiment of the present disclosure. The method is executed by a transmitting end. As shown in FIG. 1, the precoding method may include the following steps.

In step 101, a reference signal for channel estimation is sent to a receiving end.

In an embodiment of the present disclosure, the transmitting end may be, for example, a base station, and the receiving end may be, for example, a User Equipment (UE, user device).

And, in an embodiment of the present disclosure, the UE may be a device that provides voice and/or data connectivity to a user. The terminal device can communicate with one or more core networks via Radio Access Network (RAN), and UE may be an Internet of Things (IoT) terminal, such as a sensor device, a mobile phone (or called a “cellular” phone) and a computer having an IoT terminal, for example, may be a fixed, portable, pocket, hand-held, computer built-in or vehicle-mounted apparatus, such as a Station (STA), a subscriber unit, a subscriber station, a mobile station, a mobile, a remote station, an access point, a remote terminal, an access terminal, a user terminal, or a user agent. Alternatively, the UE may also be a device of an unmanned aerial vehicle. Alternatively, the UE may also be a vehicle-mounted device, for example, it may be a trip computer with a wireless communication function, or a wireless terminal connected externally to the trip computer. Alternatively, the UE may also be a roadside device, for example, it may be a street lamp, a signal lamp, or other roadside devices with a wireless communication function.

And, in an embodiment of the present disclosure, after receiving the reference signal, the receiving end may perform channel estimation on the reference signal to obtain channel information H, so that the receiving end may subsequently perform a further operation based on the channel information.

In step 102, precoding information sent by the receiving end is received.

In an embodiment of the present disclosure, the precoding information may include at least one of the following:
a Precoding Matrix Index (PMI), where the index may indicate one precoding matrix;
a mode number; where the mode number may be used to indicate: the maximum number of an OAM mode that can be transmitted under a current channel condition; or
at least one mode combination index; where the mode combination index may uniquely indicate a mode combination.

And, in an embodiment of the present disclosure, the above precoding information may be determined by the receiving end based on the channel information.

Further, when the receiving end determines the PMI in the above precoding information based on the channel information, in an embodiment of the present disclosure, the receiving end may determine based on the channel information and a UCA radius of the transmitting end; in another embodiment of the present disclosure, the receiving end may determine based on the channel information and a preset normalization value (for example, 1). Moreover, in the above two cases, the determined PMI will also be different. This part of content will be described in detail in subsequent embodiments.

And, in an embodiment of the present disclosure, the aforementioned at least one mode combination index may be an index of at least one mode combination selected by the receiving end from supported mode combinations based on the channel information H.

In addition, it should be noted that, in an embodiment of the present disclosure, there is a mapping relationship among the above-mentioned PMI, mode number, and at least one mode combination index. Based on this, in an embodiment of the present disclosure, the receiving end may only feed back at least one of the at least one mode combination index, the PMI, or the mode number to the transmitting end, and the transmitting end can determine the other two based on the mapping relationship, which saves feedback overhead. Exemplarily, in an embodiment of the present disclosure, the receiving end may only feed back the PMI to the transmitting end, and the transmitting end may determine the mode number and at least one mode combination index corresponding to the PMI based on the PMI and the mapping relationship.

In step 103, transmission mode information and a transmitting precoding weight vector are determined based on the precoding information.

In an embodiment of the present disclosure, the transmission mode information may be a mode combination used by the transmitting end and the receiving end when actually transmitting a beam. Exemplarily, in an embodiment of the present disclosure, the transmission mode information may be, for example, a mode combination of [−4, −2, −1, 0, 1, 3].

It should be noted that, in an embodiment of the present disclosure, the mode combination in the transmission mode information may be the mode combination corresponding to any index of at least one mode combination index in the precoding information sent by the receiving end. In another embodiment of the present disclosure, the mode combination in the transmission mode information may not be the mode combination corresponding to any index of at least one mode combination index in the precoding information sent by the receiving end.

And, in an embodiment of the present disclosure, when determining the transmission mode information based on the precoding information, specifically, the transmission mode information may be determined based on the mode number and/or the mode combination index in the precoding information. When the transmitting precoding weight vector is determined based on the precoding information, it may specifically be determined based on the PMI in the precoding information.

Further, in an embodiment of the present disclosure, when determining the above-mentioned transmission mode information and transmitting precoding weight vector, they may also be determined based on other factor(s). Specifically, in an embodiment of the present disclosure, the transmission mode information and the transmitting precoding weight vector may be determined based on at least one of a network resource, a current service requirement, or the precoding information.

In an embodiment of the present disclosure, the above-mentioned current service requirement may be: a current service requirement on rate and/or Block Error Ratio (BLER). The aforementioned network resource may be: the transmitting end needing to schedule the multi-mode resource considering multi-user communication.

In step 104, the transmission mode information is indicated to the receiving end.

In an embodiment of the present disclosure, the manner for the transmitting end to indicate the transmission mode information to the receiving end may be: indicating to the receiving end the transmission mode information by indicating to the receiving end the index corresponding to the mode combination in the transmission mode information.

And, in an embodiment of the present disclosure, after receiving the transmission mode information, the receiving end may determine configuration information for transmission based on the transmission mode information.

Further, in an embodiment of the present disclosure, after the transmitting end indicates the transmission mode information to the receiving end, the transmitting end may perform precoding based on the transmitting precoding vector, and perform beam transmission based on the transmission mode information, and the receiving end may perform beam reception based on the configuration information determined according to the transmission mode information indicated by the transmitting end, thereby ensuring that the transmitting end and the receiving end can perform beam transmission based on the same transmission mode information, thus avoiding the received signal energy loss and inter-mode interference in the non-aligned scenario of the transmitting end and the receiving end, and ensuring the transmission stability.

In addition, it should be noted that when the transmitting end performs precoding, in an embodiment of the present disclosure, different OAM modes may adopt different precoding, and in another embodiment of the present disclosure, different OAM modes can also adopt the same precoding.

To sum up, in the precoding method provided by the embodiments of the present disclosure, the transmitting end may send a reference signal for channel estimation to the receiving end, and then the transmitting end may receive the precoding information sent by the receiving end, and may determine the transmission mode information and the transmitting precoding weight vector based on the precoding information, and finally, the transmission mode information is indicated to the receiving end. It can be seen that, in the embodiments of the present disclosure, a precoding method is proposed, which can effectively solve the problems of received signal energy loss and inter-mode interference in a scenario where the transmitting end and the receiving end are not aligned. Moreover, the embodiment of the present disclosure is based on a digital precoding design scheme, which has low feedback overhead and high quantization accuracy.

FIG. 2 is a schematic flowchart of a precoding method provided by an embodiment of the present disclosure. The method is executed by the transmitting end. As shown in FIG. 2, the precoding method may include the following steps.

In step 201, a reference signal for channel estimation is sent to a receiving end.

In an embodiment of the present disclosure, the transmitting end may be, for example, a base station, and the receiving end may be, for example, a UE.

And, in an embodiment of the present disclosure, after receiving the reference signal, the receiving end may perform channel estimation on the reference signal to obtain channel information H, so that the receiving end may subsequently perform further operations based on the channel information.

In step 202, a UCA radius of the transmitting end is indicated to the receiving end.

In step 203, precoding information sent by the receiving end is received, where the precoding information includes at least one of at least one mode combination index, a first PMI, or a mode number.

In an embodiment of the present disclosure, the first PMI may be determined by the receiving end based on the UCA radius of the transmitting end.

And, in an embodiment of the present disclosure, the first PMI may be used to indicate a first index value and a second index value.

The first index value indicated by the first PMI is an index value of a first dimension beam corresponding to an optimal first dimension transmitting precoding weight vector determined by the receiving end based on the UCA radius of the transmitting end. The second index value indicated by the first PMI is an index value of a second dimension beam corresponding to an optimal second dimension transmitting precoding weight vector determined by the receiving end based on the UCA radius of the transmitting end. Exemplarily, in an embodiment of the present disclosure, the first dimension may be a horizontal dimension, and the second dimension may be a vertical dimension.

And, in an embodiment of the present disclosure, when the receiving end determines the first PMI based on the UCA radius of the transmitting end, it is specifically determined based on the first formula, and the first formula is as follows:

$${w}_{1 , {k}_{1 , l}} = [ 1 , {e}^{j \frac{2 π}{λ} {R}_{t} sin ( \frac{2 π}{N} \cdot ( \frac{{O}_{1} + {k}_{1 , l}}{{O}_{1}} ) )} \cdot {e}^{j \frac{2 π}{λ} {R}_{t} sin ( \frac{2 π}{N} ( \frac{{O}_{1} - {k}_{1 , l}}{{O}_{1}} ) )} , … , {e}^{j \frac{2 π}{λ} {R}_{t} sin ( \frac{2 π ( N - 1 )}{N} \cdot ( \frac{{O}_{1} + \frac{{k}_{1 , l}}{N - 1}}{{O}_{1}} ) )} \cdot {e}^{j \frac{2 π}{λ} {R}_{t} sin ( \frac{2 π ( N - 1 )}{N} ( \frac{{O}_{1} - \frac{{k}_{1 , l}}{N - 1}}{{O}_{1}} ) )} ]$$

$${w}_{2 , {k}_{2 , l}} = [ 1 , {e}^{j \frac{2 π}{λ} {R}_{t} cos ( \frac{2 π}{N} \cdot ( \frac{{O}_{2} + {k}_{2 , l}}{{O}_{2}} ) )} \cdot {e}^{j \frac{2 π}{λ} {R}_{t} cos ( \frac{2 π}{N} ( \frac{{O}_{2} - {k}_{2 , l}}{{O}_{2}} ) )} , … , {e}^{j \frac{2 π}{λ} {R}_{t} cos ( \frac{2 π ( N - 1 )}{N} \cdot ( \frac{{O}_{2} + \frac{{k}_{2 , l}}{N - 1}}{{O}_{2}} ) )} \cdot {e}^{j \frac{2 π}{λ} {R}_{t} cos ( \frac{2 π ( N - 1 )}{N} ( \frac{{O}_{2} - \frac{{k}_{2 , l}}{N - 1}}{{O}_{2}} ) )} ]$$

w_{1,k}_{_{1, l}}, w_{2,k}_{_{2,l}} are the first dimension transmitting precoding weight vector and the second dimension transmitting precoding weight vector of the UCA of the transmitting end respectively, Rₜ is the UCA radius of the transmitting end, N is the number of antenna elements at the transmitting end, O₁ and O₂ are the oversampling factors, k_{1,l}, k_{2,l} are the index value of the first dimension beam and the index value of the second dimension beam respectively, and λ is the wavelength of the electromagnetic wave. And, trigonometric function deformation can also be performed on w_{1,k}_{_{1,l}}, w_{2,k}_{_{2,l}} in the above first formula, and the changed form is no different from the above-mentioned first formula.

And, in an embodiment of the present disclosure, the method for the receiving end to determine the first PMI by using the first formula mainly includes the following steps.

In step a, the index values of all first dimension beams and second dimension beams supported by the transmitting end are obtained by traversal.

In step b, the UCA radius of the transmitting end and the index values of the first dimension beams and the index values of the second dimension beams obtained by traversal are substituted into the above first formula respectively to obtain at least one first dimension transmitting precoding weight vector and at least one second dimension transmitting precoding weight vector.

In step c, based on the channel information H pre-calculated by the receiving end, the optimal first dimension transmitting precoding weight vector under the current channel condition is determined from all the first dimension transmitting precoding weight vectors obtained in the above step b, and, the optimal second dimension transmitting precoding weight vector under the current channel condition is determined from all the second dimension transmitting precoding weight vectors obtained in the above step b.

In step d, the index value of the first dimension beam for which the optimal first dimension transmitting precoding weight vector is calculated is determined as the above-mentioned first index value, and the index value of the first dimension beam for which the optimal second dimension transmitting precoding weight vector is calculated is determined as the above-mentioned second index value.

Then, the above-mentioned first index value and second index value can be determined through the above-mentioned steps a-d.

Further, it should be noted that, in an embodiment of the present disclosure, the above-mentioned index value k_{1,l} of the first dimension beam and the index value k_{2,l} of the second dimension beam can be expressed as follows:

$$\begin{matrix}{k}_{1 , l} = p \cdot P + i \\ {k}_{2 , l} = q \cdot Q + j\end{matrix}$$

Among them, all the first dimension beams supported by the transmitting end are grouped, all the second dimension beams supported by the transmitting end are grouped, and different groups correspond to different numbering indexes. At the same time, the beams in each group are numbered in the group. And, the above uppercase P is the number of beams included in each group after the first dimension beams are grouped, the lowercase p is the numbering index of the group where the first dimension beams are located, and i is the numbering of the first dimension beam in the group; the above Q is the number of beams included in each group after the second dimension beams are grouped, q is the numbering index of the group where the second dimension beams are located, and j is the numbering of the second dimension beam in the group.

For example, in an embodiment of the present disclosure, it is assumed that the number of the first dimension beams supported by the transmitting end is 18, and the 18 first dimension beams are divided into three groups, where the numbering index corresponding to the first group is 0, the numbering index corresponding to the second group is 1, and the numbering index corresponding to the third group is 2. Each group includes 6 first dimension beams, and the 6 beams in each group are sequentially numbered as “0, 1, 2, 3, 4, 5” in the group. Based on this, for the index value of the second first dimension beam in the first group, the uppercase P should be 6, the lowercase p should be 0, and i should be 1, then the index value of the second first dimension beam in the first group k_{1,l}=0×6+1=1.

It should be noted that, in an embodiment of the present disclosure, the above uppercase P and Q may be pre-negotiated by the transmitting end and the receiving end, or may be stipulated by a standard.

Based on the above content, it can be seen that in an embodiment of the present disclosure, the index value k_{1,l} of the first dimension beam and the index value k_{2,l} of the second dimension beam are both a specific value, and the specific value is calculated based on the parameter. The index value k_{1,l} of the first dimension beam is calculated based on the first parameter (uppercase P, lowercase p, i), and the index value k_{2,l} of the second dimension beam is calculated based on the second parameter (Q, q, j).

Based on this, in an embodiment of the present disclosure, when the receiving end feeds back to the transmitting end the first PMI for indicating the above-mentioned first index value (that is, the index value of the first dimension beam corresponding to the optimal first dimension transmitting precoding weight vector determined by the receiving end based on the UCA radius of the transmitting end) and second index value (that is, the index value of the second dimension beam corresponding to the optimal second dimension transmitting precoding weight vector determined by the receiving end based on the UCA radius of the transmitting end), the first PMI may include at least one of the following:

a first index value and a second index value;

a first parameter (uppercase P, lowercase p, i) for calculating the first index value and a second parameter (Q, q, j) for calculating the second index value.

It can be seen that, in an embodiment of the present disclosure, the first dimension beams and the second dimension beams are grouped, and different parameters (that is, the number of beams included in each group, the numbering index of each group, the numbering in the group mentioned above, etc.) are set for different groups of beams. Based on this, when the receiving end moves in one direction within a certain period of time, the beam used by it may not change much, and only the numbering in the group may change, while the numbering index of each group has not changed. For example, when the receiving end moves in one direction within a certain period of time, the first dimension beam in the first group is used at the previous moment, and the second first dimension beam in the first group is used at the next moment. Therefore, the receiving end only needs to re-report the changed numbering in the group to the transmitting end, instead of reporting the numbering index of each group, which can save the feedback overhead and pilot overhead.

In addition, it should be noted that, in an embodiment of the present disclosure, there is a mapping relationship among the above-mentioned first PMI, mode number, and at least one mode combination index. Based on this, in an embodiment of the present disclosure, the receiving end can only feed back the first PMI to the transmitting end, and the transmitting end can determine the mode number and at least one mode combination index corresponding to the first PMI based on the first PMI and the mapping relationship, which can further save the feedback overhead.

And, for the introduction of “the mode number and at least one mode combination index” in the above steps, reference may be made to the description of the above embodiments, and the embodiments of the present disclosure will not repeat them here.

In step 204, transmission mode information and a transmitting precoding weight vector are determined based on the precoding information.

In an embodiment of the present disclosure, the transmitting precoding weight vector determined by the transmitting end includes the first dimension transmitting precoding weight vector determined by the transmitting end and the second dimension transmitting precoding weight vector determined by the transmitting end.

And, in an embodiment of the present disclosure, when determining the first dimension transmitting precoding weight vector determined by the transmitting end and the second dimension transmitting precoding weight vector determined by the transmitting end, they are mainly determined based on the first PMI in the precoding information.

Specifically, after receiving the first PMI, the transmitting end may determine the first index value k_{1,l} and the second index value k_{2,l} based on the first PMI, where when the first PMI includes the first index value k_{1,l} and the second index value k_{2,l}, the transmitting end can directly determine the first index value k_{1,l} and the second index value k_{2,l}; when the first PMI includes the first parameter (uppercase P, lowercase p, i) and the second parameter (Q, q, j), the transmitting end can calculate the first index value k_{1,l} based on the first parameter (uppercase P, lowercase p, i), and calculate the second index value k_{2,l} based on the second parameters (Q, q, j). Afterwards, the transmitting end can substitute the UCA radius of the transmitting end, the first index value k_{1,l} and the second index value k_{2,l} into the above first formula to determine the first dimension transmitting precoding weight vector and the second dimension transmitting precoding weight vector. The first dimension transmitting precoding weight vector is the optimal first dimension transmitting precoding weight vector under the current channel condition, and the second dimension transmitting precoding weight vector is the optimal second dimension transmitting precoding weight vector under the current channel condition.

And, for other related introductions about the above steps, reference may be made to the description of the above embodiments, and the embodiments of the present disclosure will not be repeated here.

In step 205, the transmission mode information is indicated to the receiving end.

In an embodiment of the present disclosure, the manner for the transmitting end to indicate the transmission mode information to the receiving end may be: to indicate to the receiving end the transmission mode information by indicating to the receiving end the index corresponding to the mode combination in the transmission mode information.

And, in an embodiment of the present disclosure, after receiving the transmission mode information, the receiving end may determine configuration information for transmission based on the transmission mode information.

Further, in an embodiment of the present disclosure, after the transmitting end indicates the transmission mode information to the receiving end, the transmitting end may perform precoding based on the transmitting precoding vector, and perform beam transmission based on the transmission mode information, and the receiving end may perform beam reception based on the configuration information determined according to the transmission mode information indicated by the transmitting end, thereby ensuring that the transmitting end and the receiving end can perform beam transmission based on the same transmission mode information, thus avoiding the received signal energy loss and inter-mode interference in the situation where the transmitting end and the receiving end are not aligned, and ensuring the transmission stability.

In addition, it should be noted that when the transmitting end performs precoding, in an embodiment of the present disclosure, different OAM modes may adopt different precoding, and in another embodiment of the present disclosure, different OAM modes may also adopt the same precoding.

To sum up, in the precoding method provided by the embodiments of the present disclosure, the transmitting end may send a reference signal for channel estimation to the receiving end, and then the transmitting end may receive the precoding information sent by the receiving end, and determine the transmission mode information and the transmitting precoding weight vector based on the precoding information, and finally, indicate the transmission mode information to the receiving end. It can be seen that, in the embodiments of the present disclosure, a precoding method is proposed, which can effectively solve the problems of received signal energy loss and inter-mode interference in a scenario where the transmitting end and the receiving end are not aligned. Moreover, the embodiment of the present disclosure is based on a digital precoding design scheme, which has low feedback overhead and high quantization accuracy.

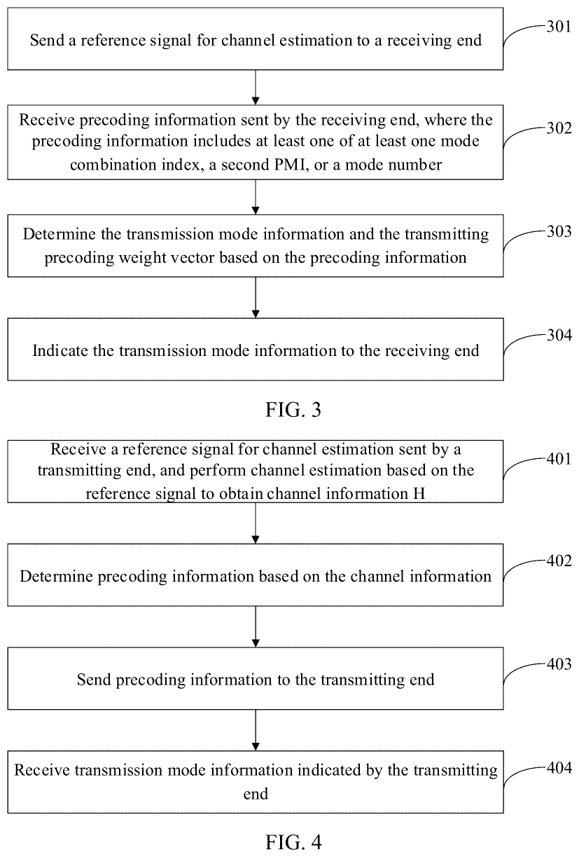

FIG. 3 is a schematic flowchart of a precoding method provided by an embodiment of the present disclosure. The method is executed by the transmitting end. As shown in FIG. 3, the precoding method may include the following steps.

In step 301, a reference signal for channel estimation is sent to a receiving end.

In an embodiment of the present disclosure, the transmitting end may be, for example, a base station, and the receiving end may be, for example, a UE.

And, in an embodiment of the present disclosure, after receiving the reference signal, the receiving end may perform channel estimation on the reference signal to obtain channel information H, so that the receiving end may subsequently perform a further operation based on the channel information.

In step 302, precoding information sent by the receiving end is received, where the precoding information includes at least one of at least one mode combination index, a second PMI, or a mode number.

In an embodiment of the present disclosure, the second PMI may be determined by the receiving end based on a normalization value, and the normalization value may be a preset value, such as 1.

And, in an embodiment of the present disclosure, the second PMI may be used to indicate a first index value and a second index value.

The first index value indicated by the second PMI is the index value of the first dimension beam corresponding to the optimal first dimension transmitting precoding weight vector determined by the receiving end based on the normalization value. The second index value indicated by the second PMI is the index value of the second dimension beam corresponding to the optimal second dimension transmitting precoding weight vector determined by the receiving end based on the normalization value. Exemplarily, in an embodiment of the present disclosure, the first dimension may be a horizontal dimension, and the second dimension may be a vertical dimension.

And, in an embodiment of the present disclosure, when the receiving end determines the second PMI based on the UCA radius of the transmitting end, it is specifically determined based on the first formula, and the first formula is as follows:

$${w}_{1 , {k}_{1 , l}} = [ 1 , {e}^{j \frac{2 π}{λ} {R}_{t} sin ( \frac{2 π}{N} \cdot ( \frac{{O}_{1} + {k}_{1 , l}}{{O}_{1}} ) )} \cdot {e}^{j \frac{2 π}{λ} {R}_{t} sin ( \frac{2 π}{N} ( \frac{{O}_{1} - {k}_{1 , l}}{{O}_{1}} ) )} , … , {e}^{j \frac{2 π}{λ} {R}_{t} sin ( \frac{2 π ( N - 1 )}{N} \cdot ( \frac{{O}_{1} + \frac{{k}_{1 , l}}{N - 1}}{{O}_{1}} ) )} \cdot {e}^{j \frac{2 π}{λ} {R}_{t} sin ( \frac{2 π ( N - 1 )}{N} ( \frac{{O}_{1} - \frac{{k}_{1 , l}}{N - 1}}{{O}_{1}} ) )} ]$$

$${w}_{2 , {k}_{2 , l}} = [ 1 , {e}^{j \frac{2 π}{λ} {R}_{t} cos ( \frac{2 π}{N} \cdot ( \frac{{O}_{2} + {k}_{2 , l}}{{O}_{2}} ) )} \cdot {e}^{j \frac{2 π}{λ} {R}_{t} cos ( \frac{2 π}{N} ( \frac{{O}_{2} - {k}_{2 , l}}{{O}_{2}} ) )} , … , {e}^{j \frac{2 π}{λ} {R}_{t} cos ( \frac{2 π ( N - 1 )}{N} \cdot ( \frac{{O}_{2} + \frac{{k}_{2 , l}}{N - 1}}{{O}_{2}} ) )} \cdot {e}^{j \frac{2 π}{λ} {R}_{t} cos ( \frac{2 π ( N - 1 )}{N} ( \frac{{O}_{2} - \frac{{k}_{2 , l}}{N - 1}}{{O}_{2}} ) )} ]$$

w_{1,k}_{_{1,l}}, w_{2,k}_{_{2,l}} are the first dimension transmitting precoding weight vector and the second dimension transmitting precoding weight vector of the UCA of the transmitting end respectively, Rₜ is the normalization value, N is the number of antenna elements at the transmitting end, O₁ and O₂ are the oversampling factors, k_{1,l}, k_{2,l} are the index value of the first dimension beam and the index value of the second dimension beam, and a, is the wavelength of the electromagnetic wave. And, in the above first formula, trigonometric function deformation can also be performed on w_{1,k}_{_{1,l}}, w_{2,k}_{_{2,l}}, and the changed form is no different from the above-mentioned first formula.

And, in an embodiment of the present disclosure, the method for the receiving end to determine the second PMI by using the first formula mainly includes the following steps.

In step A, the index values of all first dimension beams and second dimension beams supported by the transmitting end are obtained by traversal.

In step B, the normalization value and the index values of the first dimension beams and the second dimension beams obtained by traversal are substituted into the above first formula respectively to obtain at least one first dimension transmitting precoding weight vector and at least one second dimension transmitting precoding weight vector.

In step C, based on the channel information H pre-calculated by the receiving end, the optimal first dimension transmitting precoding weight vector under the current channel condition is determined from all the first dimension transmitting precoding weight vectors obtained in the above step B, and, the optimal second dimension transmitting precoding weight vector under the current channel condition is determined from all the second dimension transmitting precoding weight vectors obtained in the above step B.

In step D, the index value of the first dimension beam for which the optimal first dimension transmitting precoding weight vector is calculated is determined as the above-mentioned first index value, and the index value of the first dimension beam for which the optimal second dimension transmitting precoding weight vector is calculated is determined as the above-mentioned second index value.

Then, the above-mentioned first index value and second index value can be determined through the above-mentioned steps A-D.

Further, it should be noted that, in an embodiment of the present disclosure, the above-mentioned index value k_{1,l} of the first dimension beam and the index value k_{2,l} of the second dimension beam can be expressed as follows:

$$\begin{matrix}{k}_{1 , l} = p \cdot P + i \\ {k}_{2 , l} = q \cdot Q + j\end{matrix}$$

Among them, all the first dimension beams supported by the transmitting end are grouped, all the second dimension beams supported by the transmitting end are grouped, and different groups correspond to different numbering indexes. At the same time, the beams in each group are numbered in the group. And, the above uppercase P is the number of beams included in each group after the first dimension beams are grouped, the lowercase p is the numbering index of the group where the first dimension beam is located, and i is the numbering of the first dimension beam in the group; the above Q is the number of beams included in each group after the second dimension beams are grouped, q is the numbering index of the group where the second dimension beam is located, and j is the numbering of the second dimension beam in the group.

For example, in an embodiment of the present disclosure, it is assumed that the number of the first dimension beams supported by the transmitting end is 18, and the 18 first dimension beams are divided into three groups, where the numbering index corresponding to the first group is 0, the numbering index corresponding to the second group is 1, and the numbering index corresponding to the third group is 2. Each group includes 6 first dimension beams, and the 6 beams in each group are sequentially numbered as “0, 1, 2, 3, 4, 5” in the group. Based on this, for the index value of the second first dimension beam in the first group, the uppercase P should be 6, the lowercase p should be 0, and i should be 1, then the index value of the second first dimension beam in the first group k_{1,l}=0×6+1=1.

Based on the above content, it can be seen that, in an embodiment of the present disclosure, the index value k_{1,l} of the first dimension beam and the index value k_{2,l} of the second dimension beam are both a specific value, and the specific value is calculated based on a parameter. The index value k_{1,l} of the first dimension beam is calculated based on the first parameter (uppercase P, lowercase p, i), and the index value k_{2,l} of the second dimension beam is calculated based on the second parameter (Q, q, j).

Based on this, in an embodiment of the present disclosure, when the receiving end feeds back to the transmitting end the second PMI for indicating the above-mentioned first index value (that is, the index value of the first dimension beam corresponding to the optimal first dimension transmitting precoding weight vector determined by the receiving end based on the UCA radius of the transmitting end) and the second index value (that is, the index value of the second dimension beam corresponding to the optimal second dimension transmitting precoding weight vector determined by the receiving end based on the UCA radius of the transmitting end), the second PMI may include at least one of the following:
a first index value and a second index value;
a first parameter (uppercase P, lowercase p, i) for calculating the first index value and a second parameter (Q, q, j) for calculating the second index value.

It can be seen that, in an embodiment of the present disclosure, the first dimension beams and the second dimension beams are grouped, and different parameters are set for different groups of beams (that is, the number of beams included in each group, the numbering index of each group, the numbering in the group mentioned above, etc.). Based on this, when the receiving end moves in one direction within a certain period of time, the beam used by it may not change much, and only the numbering in the group may change, while the numbering index of each group has not changed. For example, the first first dimension beam in the first group is used at the previous moment, and the second first dimension beam in the first group is used at the next moment. Therefore, the receiving end only needs to re-report the changed numbering in the group to the transmitting end, instead of reporting the number of beams included in each group and the numbering index of each group, thereby saving feedback overhead and pilot overhead.

In addition, it should be noted that, in an embodiment of the present disclosure, there is a mapping relationship among the second PMI, the mode number, and at least one mode combination index. Based on this, in an embodiment of the present disclosure, the receiving end can only feed back the second PMI to the transmitting end, and the transmitting end can determine the mode number and at least one mode combination index corresponding to the second PMI based on the second PMI and the mapping relationship.

In addition, for the introduction of “the mode number and at least one mode combination index” in the above steps, reference may be made to the descriptions of the above embodiments, and the embodiments of the present disclosure will not be repeated here.

In step 303, the transmission mode information and the transmitting precoding weight vector are determined based on the precoding information.

In an embodiment of the present disclosure, when determining the transmitting precoding weight vector, it is mainly determined based on the second PMI in the precoding information. And, the method for determining the transmitting precoding weight vector based on the second PMI may include the following steps.

In step 1, after receiving the second PMI, the transmitting end may determine the first index value k_{1,l} and the second index value k_{2,l} based on the second PMI.

In an embodiment of the present disclosure, when the second PMI includes the first index value k_{1,l} and the second index value k_{2,l}, the transmitting end can directly determine the first index value k_{1,l} and the second index value k_{2,l}.

In another embodiment of the present disclosure, when the second PMI includes the first parameter (uppercase P, lowercase p, i) and the second parameter (Q, q, j), the transmitting end may calculate the first index value k_{1,l} based on the first parameter (uppercase P, lowercase p, i) and calculate the second index value k_{2,l} based on the second parameter (Q, q, j).

In step 2, the transmitting end substitutes the normalization value and the first index value k_{1,l} and the second index value k_{2,l} indicated by the second PMI into the first formula in the above step 302 to obtain the first weight vector.

In an embodiment of the present disclosure, the first weight vector includes: the first dimension transmitting precoding weight vector calculated based on the normalization value and the first index value k_{1,l} indicated by the second PMI, and the second dimension transmitting precoding weight vector calculated based on the normalization value and the second index value k_{2,l} indicated by the second PMI.

In step 3, the transmitting end calculates at least one second weight vector based on the UCA radius of the transmitting end.

In an embodiment of the present disclosure, the at least one second weight vector includes: at least one first dimension transmission precoding weight vector determined by the transmitting end based on the UCA radius of the transmitting end, and at least one second dimension transmitting precoding weight vector determined by the transmitting end based on the UCA radius of the transmitting end.

And, in an embodiment of the present disclosure, the method for the transmitting end to determine at least one first dimension transmitting precoding weight vector and at least one second dimension transmitting precoding weight vector based on the UCA radius of the transmitting end is similar to the method for the receiving end to determine at least one first dimension transmitting precoding weight vector and at least one second dimension transmitting precoding weight vector based on the UCA radius of the transmitting end in the above embodiments (refer to the above step a-step b), which is not elaborated in the embodiments of the present disclosure.

In step 4, the transmitting end determines a second weight vector having the smallest variance with the first weight vector among all the second weight vectors as the transmitting precoding weight vector.

In an embodiment of the present disclosure, the transmitting precoding weight vector determined by the transmitting end includes the first dimension transmitting precoding weight vector determined by the transmitting end and the second dimension transmitting precoding weight vector determined by the transmitting end.

Specifically, in an embodiment of the present disclosure, the transmitting end may determine the weight vector with the smallest variance with the first dimension transmitting precoding weight vector calculated in step 2 among all the first dimension transmitting precoding weight vectors determined in step 3 as the first dimension transmitting precoding weight vector determined by the transmitting end; the transmitting end may determine the weight vector with the smallest variance with the second dimension transmitting precoding weight vector calculated in step 2 among all the second dimension transmitting precoding weight vectors determined in step 3 as the second dimension transmitting precoding weight vector determined by the transmitting end.

As an example, in an embodiment of the present disclosure, it is assumed that all the first dimension transmitting precoding weight vectors determined in the above step 3 include: ω_{1, k}_{_{1,l}}′, ω_{1, k}_{_{1,l}}″ the first dimension transmitting precoding weight vector calculated in the above step 2 is ω′, where the variance of ω_{1, k}_{_{1,l}}′ and ω′ is δ₁², the variance of ω_{1, k}_{_{1,l}}″ and ω′ is δ₂², δ₂²<δ₁². Then it can be determined that the variance of ω_{1, k}_{_{1,l}}″ and ω′ is the smallest in ω_{1, k}_{_{1,l}}′ and ω_{1, k}_{_{1,l}}″. Therefore, ω_{1, k}_{_{1,l}}″ is determined as the first dimension transmitting precoding weight vector determined by the transmitting end. Similarly, the second dimension transmission precoding weight vector determined by the transmitting end can also be determined.

Then, the transmitting precoding weight vector can be determined by performing the above steps 1-4.

In addition, for other relevant introductions about the above step 303, reference may be made to the description of the above embodiments, and the embodiments of the present disclosure will not repeat them here.

In step 304, the transmission mode information is indicated to the receiving end.

In an embodiment of the present disclosure, the manner for the transmitting end to indicate the transmission mode information to the receiving end may be: indicating to the receiving end the transmission mode information by indicating to the receiving end the index corresponding to the mode combination in the transmission mode information.

And, in an embodiment of the present disclosure, after receiving the transmission mode information, the receiving end may determine configuration information for transmission based on the transmission mode information.

Further, in an embodiment of the present disclosure, after the transmitting end indicates the transmission mode information to the receiving end, the transmitting end may perform precoding based on the transmission precoding vector, and perform beam transmission based on the transmission mode information, and the receiving end may perform beam reception based on the configuration information determined according to the transmission mode information indicated by the transmitting end, thereby ensuring that the transmitting end and the receiving end can perform beam transmission based on the same transmission mode information, thus avoiding the received signal energy loss and inter-mode interference in the situation where the transmitting end and the receiving end are not aligned, and ensuring transmission stability.

In addition, it should be noted that when the transmitting end performs precoding, in an embodiment of the present disclosure, different OAM modes may adopt different precoding, and in another embodiment of the present disclosure, different OAM modes may also adopt the same precoding.

To sum up, in the precoding method provided by the embodiments of the present disclosure, the transmitting end may send a reference signal for channel estimation to the receiving end, and then the transmitting end may receive the precoding information sent by the receiving end, and may determine the transmission mode information and the transmitting precoding weight vector based on the precoding information, and finally, may indicate the transmission mode information to the receiving end. It can be seen that, in the embodiments of the present disclosure, a precoding method is proposed, which can effectively solve the problems of received signal energy loss and inter-mode interference in a scenario where the transmitting end and the receiving end are not aligned. Moreover, the embodiment of the present disclosure is based on a digital precoding design scheme, which has low feedback overhead and high quantization accuracy.

FIG. 4 is a schematic flowchart of a precoding method provided by an embodiment of the present disclosure. The method is executed by the receiving end. As shown in FIG. 4, the precoding method may include the following steps.

In step 401, a reference signal for channel estimation sent by a transmitting end is received, and channel estimation is performed based on the reference signal to obtain channel information H.

In step 402, precoding information is determined based on the channel information.

In an embodiment of the present disclosure, the precoding information may include at least one of at least one mode combination index, a PMI, or a mode number; where the mode number is used to indicate: the maximum number of orbital angular momentum (OAM) modes that can be transmitted under the current channel condition.

In step 403, the precoding information is sent to the transmitting end.

In step 404, transmission mode information indicated by the transmitting end is received.

For relevant introductions about steps 401-404, reference may be made to the descriptions of the foregoing embodiments, and the embodiments of the present disclosure will not be repeated here.

To sum up, in the precoding method provided by the embodiments of the present disclosure, the transmitting end may send a reference signal for channel estimation to the receiving end, and then the transmitting end may receive the precoding information sent by the receiving end, and determine the transmission mode information and the transmission precoding weight vector based on the precoding information, and finally, indicate the transmission mode information to the receiving end. It can be seen that, in the embodiments of the present disclosure, a precoding method is proposed, which can effectively solve the problems of received signal energy loss and inter-mode interference in a scenario where the transmitting end and the receiving end are not aligned. Moreover, the embodiment of the present disclosure is based on a digital precoding design scheme, which has low feedback overhead and high quantization accuracy.

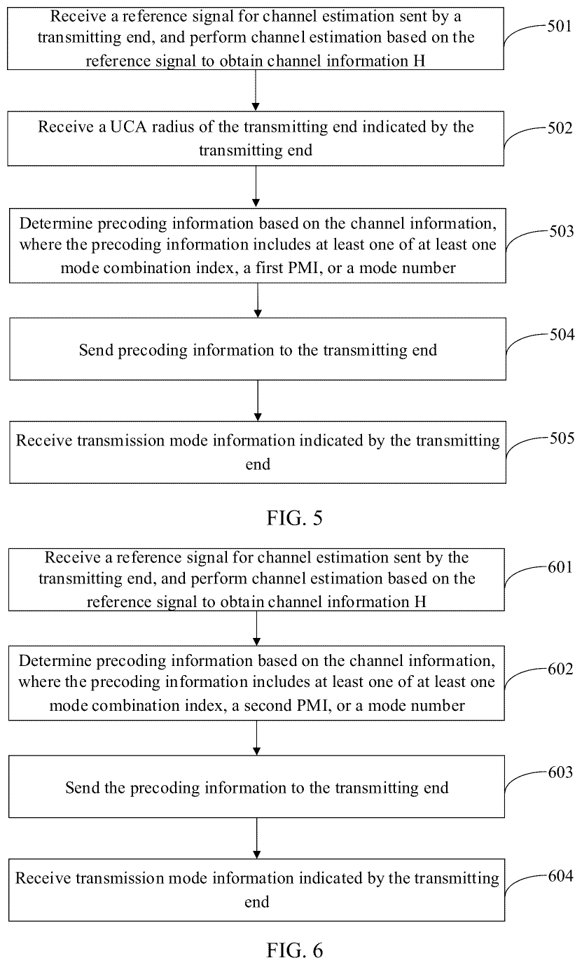

FIG. 5 is a schematic flowchart of a precoding method provided by an embodiment of the present disclosure. The method is executed by the receiving end. As shown in FIG. 4, the precoding method may include the following steps.

In step 501, a reference signal for channel estimation sent by a transmitting end is received, and channel estimation is performed based on the reference signal to obtain channel information H.

In step 502, a UCA radius of the transmitting end indicated by the transmitting end is received.

In step 503, precoding information is determined based on the channel information, where the precoding information includes at least one of at least one mode combination index, a first PMI, or a mode number.

In step 504, the precoding information is sent to the transmitting end.

In step 505, transmission mode information indicated by the transmitting end is received.

For relevant introductions about steps 501-505, reference may be made to the descriptions of the foregoing embodiments, and the embodiments of the present disclosure will not be repeated here.

To sum up, in the precoding method provided by the embodiments of the present disclosure, the transmitting end may send a reference signal for channel estimation to the receiving end, and then the transmitting end may receive the precoding information sent by the receiving end, and may determine the transmission mode information and the transmission precoding weight vector based on the precoding information, and finally, may indicate the transmission mode information to the receiving end. It can be seen that, in the embodiments of the present disclosure, a precoding method is proposed, which can effectively solve the problems of received signal energy loss and inter-mode interference in a scenario where the transmitting end and the receiving end are not aligned. Moreover, the embodiment of the present disclosure is based on a digital precoding design scheme, which has low feedback overhead and high quantization accuracy.

FIG. 6 is a schematic flowchart of a precoding method provided by an embodiment of the present disclosure. The method is executed by the receiving end. As shown in FIG. 4, the precoding method may include the following steps.

In step 601, a reference signal for channel estimation sent by the transmitting end is received, and channel estimation is performed based on the reference signal to obtain channel information H.

In step 602, precoding information is determined based on the channel information, where the precoding information includes at least one of at least one mode combination index, a second PMI, or a mode number.

In step 603, the precoding information is sent to the transmitting end.

In step 604, transmission mode information indicated by the transmitting end is received.

For relevant introductions about steps 601-604, reference may be made to the descriptions of the foregoing embodiments, and details are not described in the embodiments of the present disclosure.

To sum up, in the precoding method provided by the embodiments of the present disclosure, the transmitting end may send a reference signal for channel estimation to the receiving end, and then the transmitting end may receive the precoding information sent by the receiving end, and may determine the transmission mode information and the transmitting precoding weight vector based on the precoding information, and finally, may indicate the transmission mode information to the receiving end. It can be seen that, in the embodiments of the present disclosure, a precoding method is proposed, which can effectively solve the problems of received signal energy loss and inter-mode interference in a scenario where the transmitting end and the receiving end are not aligned. Moreover, the embodiment of the present disclosure is based on a digital precoding design scheme, which has low feedback overhead and high quantization accuracy.

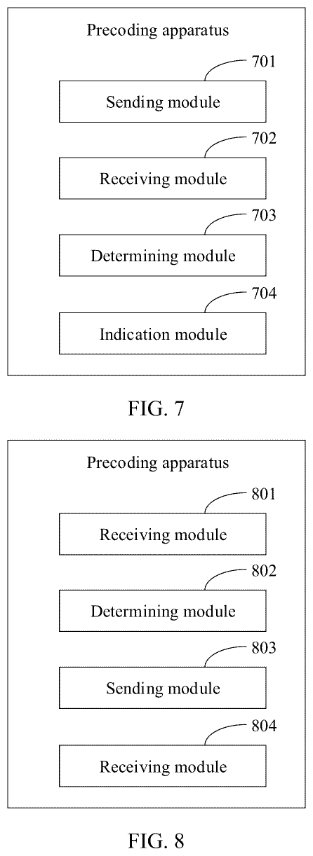

FIG. 7 is an apparatus structure diagram of a precoding method provided by an embodiment of the present disclosure. As shown in FIG. 7, the precoding apparatus may include:
a sending module 701, configured to send a reference signal for channel estimation to a receiving end;
a receiving module 702, configured to receive precoding information sent by the receiving end, where the precoding information includes at least one of at least one mode combination index, a precoding matrix index (PMI), or a mode number; the mode number is used to indicate: the maximum number of orbital angular momentum (OAM) modes that can be transmitted under a current channel condition;
a determining module 703, configured to determine transmission mode information and a transmitting precoding weight vector based on the precoding information;
an indication module 704, configured to indicate the transmission mode information to the receiving end.

To sum up, in the precoding apparatus provided by the embodiments of the present disclosure, the transmitting end may send a reference signal for channel estimation to the receiving end, and then the transmitting end may receive the precoding information sent by the receiving end, and may determine the transmission mode information and the transmission precoding weight vector based on the precoding information, and finally, may indicate the transmission mode information to the receiving end. It can be seen that, in the embodiments of the present disclosure, a precoding method is proposed, which can effectively solve the problems of received signal energy loss and inter-mode interference in a scenario where the transmitting end and the receiving end are not aligned. Moreover, the embodiment of the present disclosure is based on a digital precoding design scheme, which has low feedback overhead and high quantization accuracy.

Optionally, in an embodiment of the present disclosure, the apparatus is further configured to:

indicate a uniform circular array (UCA) radius Rt of the transmitting end to the receiving end.

Optionally, in an embodiment of the present disclosure, the PMI is a first PMI, and the first PMI is determined by the receiving end based on the UCA radius of the transmitting end.

Optionally, in an embodiment of the present disclosure, the first PMI is used to indicate a first index value and a second index value;
the first index value is an index value of a first dimension beam corresponding to an optimal first dimension transmitting precoding weight vector determined by the receiving end based on the UCA radius of the transmitting end;
the second index value is an index value of a second dimension beam corresponding to an optimal second dimension transmitting precoding weight vector determined by the receiving end based on the UCA radius of the transmitting end.

Optionally, in an embodiment of the present disclosure, the first PMI includes at least one of the following:
the first index value and the second index value;
a first parameter and a second parameter, where the first parameter is used to calculate the first index value, and the second parameter is used to calculate the second index value.

Optionally, in an embodiment of the present disclosure, the determining module is further configured to:
determine the transmitting precoding weight vector based on the first PMI.
Optionally, in an embodiment of the present disclosure, there is a mapping relationship among the first PMI, the mode number, and at least one mode combination index.

Optionally, in an embodiment of the present disclosure, the PMI is a second PMI, and the second PMI is determined by the receiving end based on a normalization value, and the normalization value is preset value.

Optionally, in an embodiment of the present disclosure, the second PMI is used to indicate a first index value and a second index value;
where the first index value is an index value of a first dimension beam corresponding to an optimal first dimension transmitting precoding weight vector determined by the receiving end based on the normalization value;
the second index value is an index value of a second dimension beam corresponding to an optimal second dimension transmitting precoding weight vector determined by the receiving end based on the normalization value.

Optionally, in an embodiment of the present disclosure, the second PMI includes at least one of the following:
the first index value and the second index value;
a first parameter and a second parameter, where the first parameter is used to calculate the first index value, and the second parameter is used to calculate the second index value.

Optionally, in an embodiment of the present disclosure, the determining module is further configured to:
determine the transmitting precoding weight vector based on the second PMI.

Optionally, in an embodiment of the present disclosure, the determining module is further configured to:
calculate a first weight vector based on the second PMI and the normalization value, calculate at least one second weight vector based on the UCA radius of the transmitting end, and determine a second weight vector among all the second weight vectors that has a minimum variance with the first weight vector as the transmitting precoding weight vector.

Optionally, in an embodiment of the present disclosure, there is a mapping relationship among the second PMI, the mode number, and at least one mode combination index.

Optionally, in an embodiment of the present disclosure, the apparatus is further configured to:
determine the transmission mode information and the transmitting precoding weight vector based on at least one of a network resource, a current service requirement, or the precoding information.

Optionally, in an embodiment of the present disclosure, the transmission mode information is a mode combination used when the transmitting end and the receiving end actually transmit a beam.

FIG. 8 is an apparatus structure diagram of a precoding method provided by an embodiment of the present disclosure. The method is executed by a UE. As shown in FIG. 8, the precoding apparatus may include:
a receiving module 801, configured to receive a reference signal for channel estimation sent by the transmitting end, and perform channel estimation based on the reference signal to obtain channel information;
a determining module 802, configured to determine precoding information based on the channel information, where the precoding information includes at least one of at least one mode combination index, a PMI, or a mode number; the mode number is used to indicate: the maximum number of orbital angular momentum (OAM) modes that can be transmitted under a current channel condition;
a sending module 803, configured to send the precoding information to the transmitting end;
a receiving module 804, configured to receive transmission mode information indicated by the transmitting end.

To sum up, in the precoding apparatus provided by the embodiments of the present disclosure, the transmitting end may send a reference signal for channel estimation to the receiving end, and then the transmitting end may receive the precoding information sent by the receiving end, and may determine the transmission mode information and the transmitting precoding weight vector based on the precoding information, and finally, may indicate the transmission mode information to the receiving end. It can be seen that, in the embodiments of the present disclosure, a precoding method is proposed, which can effectively solve the problems of received signal energy loss and inter-mode interference in a scenario where the transmitting end and the receiving end are not aligned. Moreover, the embodiment of the present disclosure is based on a digital precoding design scheme, which has low feedback overhead and high quantization accuracy.

Optionally, in an embodiment of the present disclosure, the apparatus is further configured to:
receive a UCA radius of the transmitting end indicated by the transmitting end.

Optionally, in an embodiment of the present disclosure, the PMI is a first PMI, and the first PMI is determined by the receiving end based on the UCA radius of the transmitting end.

Optionally, in an embodiment of the present disclosure, the first PMI is used to indicate a first index value and a second index value;
where the first index value is an index value of a first dimension beam corresponding to an optimal first dimension transmitting precoding weight vector determined by the receiving end based on the UCA radius of the transmitting end;
the second index value is an index value of a second dimension beam corresponding to an optimal second dimension transmitting precoding weight vector determined by the receiving end based on the UCA radius of the transmitting end.

Optionally, in an embodiment of the present disclosure, the first PMI includes at least one of the following:
the first index value and the second index value; or
a first parameter and a second parameter, where the first parameter is used to calculate the first index value, and the second parameter is used to calculate the second index value.

Optionally, in an embodiment of the present disclosure, there is a mapping relationship among the first PMI, the mode number, and at least one mode combination index.

Optionally, in an embodiment of the present disclosure, the PMI is a second PMI, and the second PMI is determined by the receiving end based on a normalization value, and the normalization value is preset value.

Optionally, in an embodiment of the present disclosure, the second PMI is used to indicate a first index value and a second index value;
where the first index value is an index value of a first dimension beam corresponding to an optimal first dimension transmitting precoding weight vector determined by the receiving end based on the normalization value;
the second index value is an index value of a second dimension beam corresponding to an optimal second dimension transmitting precoding weight vector determined by the receiving end based on the normalization value.

Optionally, in an embodiment of the present disclosure, the second PMI includes at least one of the following:
the first index value and the second index value;
a first parameter and a second parameter, where the first parameter is used to calculate the first index value, and the second parameter is used to calculate the second index value.

Optionally, in an embodiment of the present disclosure, there is a mapping relationship among the second PMI, the mode number, and at least one mode combination index.

Optionally, in an embodiment of the present disclosure, the transmission mode information is a mode combination used when the transmitting end and the receiving end actually transmit a beam.

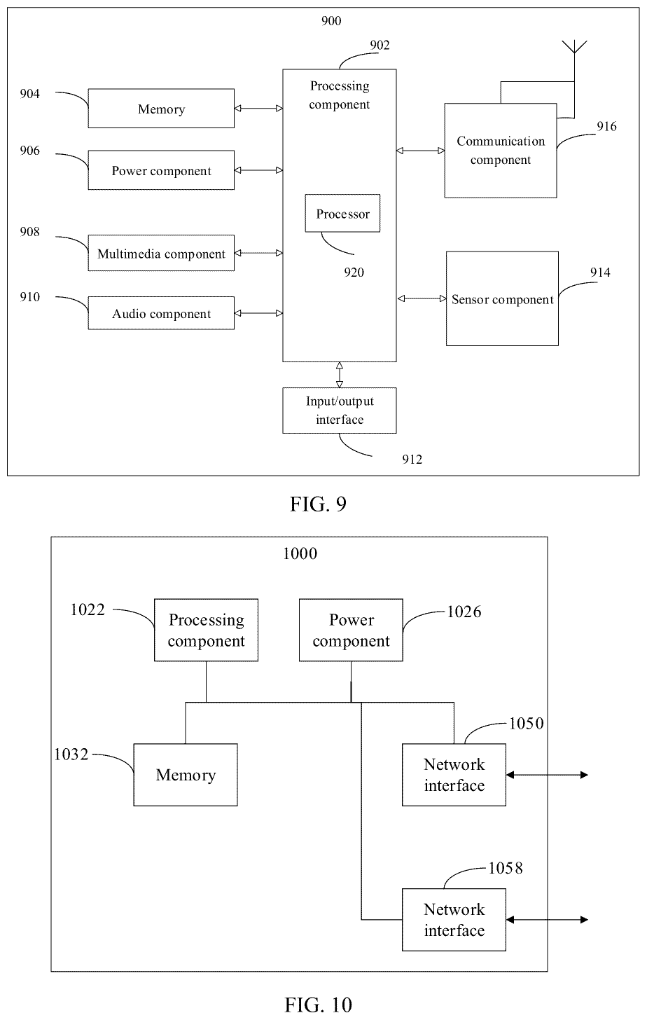

FIG. 9 is a block diagram of a user equipment (UE) 900 provided by an embodiment of the present disclosure. For example, the UE 900 may be a mobile phone, a computer, a digital broadcast terminal device, a messaging device, a game console, a tablet, a medical device, exercise equipment, a personal digital assistant, and the like.

Referring to FIG. 9, the UE 900 may include one or more of the following components: a processing component 902, a memory 904, a power component 906, a multimedia component 908, an audio component 910, an input/output (VO) interface 912, a sensor component 913, and a communication component 916.

The processing component 902 typically controls overall operations of the UE 900, such as the operations associated with display, telephone calls, data communications, camera operations, and recording operations. The processing component 902 may include one or more processors 920 to execute instructions to perform all or part of the steps in the above described methods. Moreover, the processing component 902 may include one or more modules which facilitate the interaction between the processing component 902 and other components. For instance, the processing component 902 may include a multimedia module to facilitate the interaction between the multimedia component 908 and the processing component 902.

The memory 904 is configured to store various types of data to support the operation of the UE 900. Examples of such data include instructions for any applications or methods operated on the UE 900, contact data, phonebook data, messages, pictures, video, etc. The memory 904 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 906 provides power to various components of the UE 900. The power component 906 may include a power management system, one or more power sources, and any other components associated with the generation, management, and distribution of power in the UE 900.

The multimedia component 908 includes a screen providing an output interface between the UE 900 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a wake-up time and a pressure associated with the touch or swipe operation. In some embodiments, the multimedia component 908 includes a front camera and/or a rear camera. The front camera and the rear camera may receive an external multimedia datum while the UE 900 is in an operation mode, such as a photographing mode or a video mode. Each of the front camera and the rear camera may be a fixed optical lens system or have focus and optical zoom capability.

The audio component 910 is configured to output and/or input audio signals. For example, the audio component 910 includes a microphone (“MIC”) configured to receive an external audio signal when the UE 900 is in an operation mode, such as a call mode, a recording mode, and a voice recognition mode. The received audio signal may be further stored in the memory 904 or transmitted via the communication component 916. In some embodiments, the audio component 910 further includes a speaker to output audio signals.

The I/O interface 912 provides an interface between the processing component 902 and peripheral interface modules, such as a keyboard, a click wheel, buttons, and the like. The buttons may include, but are not limited to, a home button, a volume button, a starting button, and a locking button.

The sensor component 913 includes one or more sensors to provide status assessments of various aspects of the UE 900. For instance, the sensor component 913 may detect an open/closed status of the device 900, relative positioning of components, e.g., the display and the keypad, of the UE 900, a change in position of the UE 900 or a component of the UE 900, a presence or absence of user contact with the UE 900, an orientation or an acceleration/deceleration of the UE 900, and a change in temperature of the UE 900. The sensor component 913 may include a proximity sensor configured to detect the presence of nearby objects without any physical contact. The sensor component 913 may also include a light sensor, such as a CMOS or CCD image sensor, for use in imaging applications. In some embodiments, the sensor component 913 may also include an accelerometer sensor, a gyroscope sensor, a magnetic sensor, a pressure sensor, or a temperature sensor.

The communication component 916 is configured to facilitate communication, wired or wirelessly, between the UE 900 and other devices. The UE 900 can access a wireless network based on a communication standard, such as WiFi, 2G, or 3G, or a combination thereof. In one exemplary embodiment, the communication component 916 receives a broadcast signal or broadcast associated information from an external broadcast management system via a broadcast channel. In one exemplary embodiment, the communication component 916 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the UE 900 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

FIG. 10 is a block diagram of a network side device 1000 for according to an embodiment of the present disclosure. For example, the network side device 1000 may be provided as a network-side device. Referring to FIG. 10, the network side device 1000 includes a processing component 1011 that further includes one or more processors, and memory resources represented by a memory 1032 for storing instructions executable by the processing component 1022, such as application programs. The application programs stored in the memory 1032 may include one or more modules each corresponding to a set of instructions. Further, the processing component 1010 is configured to execute the instructions to execute any of the above-mentioned methods applied to the network side device, for example, the method shown in FIG. 1.

The network side device 1000 may also include a power component 1026 configured to perform power management of the network side device 1000, a wired or wireless network interface 1050 configured to connect the network side device 1000 to a network, and an input/output (I/O) interface 1058. The network side device 1000 may operate based on an operating system stored in the memory 1032, such as Windows Server™, Mac OS X™, Unix™ Linux™, FreeBSD™, or the like.

In the above embodiments provided in the present disclosure, the methods provided in the embodiments of the present disclosure are introduced from the perspectives of the network side device and the UE respectively. In order to implement the various functions in the method provided by the above embodiments of the present disclosure, the network side device and the UE may include a hardware structure and a software module, and the above functions are implemented in the form of a hardware structure, a software module, or a hardware structure plus a software module. A certain function among the above-mentioned functions may be implemented in the form of a hardware structure, a software module, or a hardware structure plus a software module.

In the above embodiments provided in the present disclosure, the methods provided in the embodiments of the present disclosure are introduced from the perspectives of the network side device and the UE respectively. In order to implement the various functions in the method provided by the above embodiments of the present disclosure, the network side device and the UE may include a hardware structure and a software module, and the above functions are implemented in the form of a hardware structure, a software module, or a hardware structure plus a software module. A certain function among the above-mentioned functions may be implemented in the form of a hardware structure, a software module, or a hardware structure plus a software module.

An embodiment of the present disclosure provides a communication apparatus. The communication device may include a transceiver module and a processing module. The transceiver module may include a sending module and/or a receiving module, the sending module is used to realize the sending function, the receiving module is used to realize the receiving function, and the transceiver module can realize the sending function and/or the receiving function.

The communication apparatus may be a terminal device (such as the terminal device in the foregoing method embodiments), may also be an apparatus in the terminal device, and may also be an apparatus that can be matched and used with the terminal device. Alternatively, the communication apparatus may be a network device, or an apparatus in the network device, or an apparatus that can be matched with the network device.

An embodiment of the present disclosure provides another communication apparatus. The communication apparatus may be a network device, or a terminal device (such as the terminal device in the foregoing method embodiments), or a chip, a chip system, or a processor that supports the network device to implement the above method, or a chip, a chip system, or a processor that supports the terminal device to implement the above method. The apparatus can be used to implement the methods described in the above method embodiments, and for details, the descriptions in the above method embodiments may be referred to.

The communication apparatus may include one or more processors. The processor may be a general purpose processor or a special purpose processor or the like. For example, it can be a baseband processor or a central processing unit. The baseband processor can be used to process communication protocols and communication data, and the central processing unit can be used to control communication devices (such as network side devices, baseband chips, terminal devices, terminal device chips, DU or CU, etc.), execute the computer program, and process data of the computer program.

Optionally, the communication apparatus may further include one or more memories, on which computer programs may be stored, and the processor executes the computer program, so that the communication apparatus executes the methods described in the foregoing method embodiments. Optionally, data may also be stored in the memory. The communication apparatus and the memory can be set separately or integrated together.

Optionally, the communication apparatus may further include a transceiver and an antenna. The transceiver may be referred to as a transceiver unit, a transceiver machine, or a transceiver circuit, etc., and is used to implement a transceiver function. The transceiver may include a receiver and a transmitter, and the receiver may be called a receiving machine or a receiving circuit for realizing a receiving function; the transmitter may be called a sending machine or a sending circuit for realizing a sending function.

Optionally, the communication apparatus may further include one or more interface circuits. The interface circuit is used to receive code instructions and transmit them to the processor. The processor executes the code instructions to enable the communication apparatus to execute the methods described in the foregoing method embodiments.

The communication apparatus is a terminal device (such as the terminal device in the foregoing method embodiments): the processor is configured to execute the method shown in any one of FIGS. 1-4.

The communication apparatus is a network device: the transceiver is used to execute the method shown in any one of FIGS. 5-7.

In an implementation, the processor may include a transceiver for implementing receiving and sending functions. For example, the transceiver may be a transceiver circuit, or an interface, or an interface circuit. The transceiver circuit, interface or interface circuit for realizing the functions of receiving and sending can be separated or integrated together. The above-mentioned transceiver circuit, interface or interface circuit may be used for reading and writing code/data, or the above-mentioned transceiver circuit, interface or interface circuit may be used for signal transmission or transfer.

In an implementation, the processor may store a computer program, and the computer program runs on the processor, and may cause the communication apparatus to execute the methods described in the foregoing method embodiments. The computer program may be solidified in the processor, and in this case, the processor may be implemented by hardware.

In an implementation, the communication apparatus may include a circuit, and the circuit may implement the function of sending or receiving or communicating in the foregoing method embodiments. The processors and transceivers described in the present disclosure can be implemented in an integrated circuit (IC), an analog IC, a radio frequency integrated circuit (RFIC), a mixed-signal IC, an application specific integrated circuit (ASIC), a printed circuit board (PCB), an electronic equipment, etc. The processor and the transceiver can also be fabricated using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon germanium (SiGe), gallium arsenide (GaAs), etc.

The communication apparatus described in the above embodiments may be a network device or a terminal device (such as the terminal device in the above-mentioned method embodiments), but the scope of the communication apparatus described in the present disclosure is not limited thereto, and the structure of the communication apparatus may not be limited. The communication apparatus may be a stand-alone device or may be part of a relatively large device. For example, the communication apparatus may be:
(1) a stand-alone integrated circuit (IC), or a chip, or a chip system or a subsystem;
(2) a set with one or more ICs, optionally, the set of ICs may also include a storage component for storing data and the computer program;
(3) ASIC, such as a Modem;
(4) a module that can be embedded in another device;
(5) a receiver, a terminal device, an intelligent terminal device, a cellular phone, a wireless device, a handset, a mobile unit, a vehicle-mounted device, a network device, a cloud device, an artificial intelligence device, etc.;
(6) others and so on.

For the case where the communication apparatus may be a chip or a chip system, the chip includes a processor and an interface. The number of processors may be one or more, and the number of interfaces may be more than one.

Optionally, the chip further includes a memory for storing necessary computer programs and data.

Those skilled in the art can also understand that various illustrative logical blocks and steps listed in the embodiments of the present disclosure can be implemented by an electronic hardware, computer software, or a combination of both. Whether such functions are implemented by hardware or software depends on the specific application and the design requirements of the overall system. Those skilled in the art may use various methods to implement the described functions for each specific application, but such implementation should not be understood as going beyond the protection scope of the embodiments of the present application.

An embodiment of the present disclosure also provides a system for determining a duration of a sidelink, the system includes a communication apparatus as a terminal device (such as the first terminal device in the method embodiment above) and a communication apparatus as a network device in the foregoing embodiments. Alternatively, the system includes the communication apparatus as the terminal device in the foregoing embodiments (such as the first terminal device in the foregoing method embodiment) and the communication device as a network device.

The present disclosure also provides a readable storage medium on which instructions are stored, and when the instructions are executed by a computer, the functions of any one of the above method embodiments are realized.

The present disclosure also provides a computer program product, which implements the functions of any one of the above method embodiments when the computer program product is executed by a computer.

In the above embodiments, all or part of them may be implemented by software, hardware, firmware or any combination thereof. When implemented using software, it may be implemented in whole or in part in the form of a computer program product. The computer program product includes one or more computer programs. When the computer program is loaded and executed on the computer, all or part of the processes or functions according to the embodiments of the present disclosure are generated. The computer can be a general purpose computer, a special purpose computer, a computer network, or other programmable apparatuses. The computer program can be stored in the computer-readable storage medium or transmitted from one computer-readable storage medium to another computer-readable storage medium, for example, the computer program can be transmitted from one website, computer, server or data center to another website site, computer, server or data center by wired (such as a coaxial cable, an optical fiber, a digital subscriber line (DSL)) or wireless (such as infrared, wireless, microwave, etc.) manner. The computer-readable storage medium may be any available medium that can be accessed by a computer, or a data storage device such as a server or a data center integrated with one or more available media. The available medium may be a magnetic medium (for example, a floppy disk, a hard disk, a magnetic tape), an optical medium (for example, a digital video disc (DVD)), or a semiconductor medium (for example, a solid state disk (SSD)), etc.

Those of ordinary skill in the art can understand that the first, second, and other numbers involved in the present disclosure are only for convenience of description, and are not used to limit the scope of the embodiments of the present disclosure, and also indicate the sequence.

At least one in the present disclosure can also be described as one or more, and a plurality of can be two, three, four or more, which is not limited in the present disclosure. In the embodiments of the present disclosure, for a technical feature, the technical features are distinguished by “first”, “second”, “third”, “A”, “B”, “C” and “D”, etc. The technical features described by the “first”, “second”, “third”, “A”, “B”, “C” and “D” have no sequence or order of magnitude therebetween.

Other embodiments of the present disclosure will be readily apparent to those skilled in the art from consideration of the specification and practice of the contents disclosed herein. The present disclosure is intended to cover any modification, use or adaptation of the present application, and these modifications, uses or adaptations follow the general principles of the present disclosure and include common knowledge or habitual technical means in the technical field not disclosed in the present disclosure. The specification and the embodiments are only considered exemplary, and the true scope and spirit of the present disclosure are indicated by the appended claims.

It should be understood that the present disclosure is not limited to the precise constructions which have been described above and shown in the drawings, and various modifications and changes may be made without departing from the scope thereof. The scope of the present disclosure is limited only by the scope of the appended claims.

1. A precoding method applied to a transmitting end, wherein the method comprises:
sending a reference signal for channel estimation to a receiving end;
receiving precoding information sent by the receiving end, wherein the precoding information comprises at least one of at least one mode combination index, a precoding matrix index (PMI), or a mode number; the mode number is used to indicate: a maximum number of an orbital angular momentum (OAM) mode that can be transmitted under a current channel condition;
determining transmission mode information and a transmitting precoding weight vector based on the precoding information; and
indicating the transmission mode information to the receiving end.

2. The method according to claim 1, further comprising:
indicating a uniform circular array (UCA) radius Rt of the transmitting end to the receiving end.

3. The method according to claim 2, wherein the PMI is a first PMI, and the first PMI is determined by the receiving end based on the UCA radius of the transmitting end.

4. The method according to claim 3, wherein the first PMI is used to indicate a first index value and a second index value;
wherein the first index value is an index value of a first dimension beam corresponding to an optimal first dimension transmitting precoding weight vector determined by the receiving end based on the UCA radius of the transmitting end;
the second index value is an index value of a second dimension beam corresponding to an optimal second dimension transmitting precoding weight vector determined by the receiving end based on the UCA radius of the transmitting end.

5. The method according to claim 4, wherein the first PMI comprises at least one of:
the first index value and the second index value; or
a first parameter and a second parameter, wherein the first parameter is used to calculate the first index value, and the second parameter is used to calculate the second index value.

6. The method according to claim 3, wherein determining the transmitting precoding weight vector based on the precoding information comprises:
determining the transmitting precoding weight vector based on the first PMI.

7. The method according to claim 3, wherein a mapping relationship exists among the first PMI, the mode number, and the at least one mode combination index.

8. The method according to claim 1, wherein the PMI is a second PMI, the second PMI is determined by the receiving end based on a normalization value, and the normalization value is a preset value.

9. The method according to claim 8, wherein the second PMI is used to indicate a first index value and a second index value;
wherein the first index value is an index value of a first dimension beam corresponding to an optimal first dimension transmitting precoding weight vector determined by the receiving end based on the normalization value;
the second index value is an index value of a second dimension beam corresponding to an optimal second dimension transmitting precoding weight vector determined by the receiving end based on the normalization value.

10. The method according to claim 9, wherein the second PMI comprises at least one of:
the first index value and the second index value; or
a first parameter and a second parameter, wherein the first parameter is used to calculate the first index value, and the second parameter is used to calculate the second index value.

11. The method according to claim 8, wherein determining the transmitting precoding weight vector based on the precoding information comprises:
determining the transmitting precoding weight vector based on the second PMI.

12. The method according to claim 11, wherein determining the transmitting precoding weight vector based on the second PMI comprises:
calculating a first weight vector based on the second PMI and the normalization value, calculating at least one second weight vector based on a UCA radius of the transmitting end, and determining a second weight vector among all the second weight vectors that has a minimum variance with the first weight vector as the transmitting precoding weight vector.

13. The method according to claim 8, wherein a mapping relationship exists among the second PMI, the mode number, and the at least one mode combination index.

14. The method according to claim 1, further comprising:
determining the transmission mode information and the transmitting precoding weight vector based on at least one of a network resource, a current service requirement, or the precoding information.

15. The method according to claim 1, wherein the transmission mode information is a mode combination used when the transmitting end and the receiving end actually transmit a beam.

16. A precoding method applied to a receiving end, wherein the method comprises:
receiving a reference signal for channel estimation sent by a transmitting end, and performing a channel estimation based on the reference signal to obtain channel information;
determining precoding information based on the channel information, wherein the precoding information comprises at least one of at least one mode combination index, a PMI, or a mode number; the mode number is used to indicate: a maximum number of an orbital angular momentum (OAM) mode that can be transmitted under a current channel condition;
sending the precoding information to the transmitting end; and
receiving transmission mode information indicated by the transmitting end.

17. The method according to claim 16, further comprising:
receiving a UCA radius of the transmitting end indicated by the transmitting end.

18. The method according to claim 17, wherein the PMI is a first PMI, and the first PMI is determined by the receiving end based on the UCA radius of the transmitting end.

19-21. (canceled)

22. The method according to claim 16, wherein the PMI is a second PMI, the second PMI is determined by the receiving end based on a normalization value, and the normalization value is a preset value.

23-28. (canceled)

29. A communication apparatus, comprising a processor and a memory, wherein a computer program is stored in the memory, and the processor executes the computer program stored in the memory, so that the apparatus performs;
sending a reference signal for channel estimation to a receiving end;
receiving precoding information sent by the receiving end, wherein the precoding information comprises at least one of at least one mode combination index, a precoding matrix index (PMI),
or a mode number, the mode number is used to indicate: a maximum number of an orbital angular momentum (OAM) mode that can be transmitted under a current channel condition;
determining transmission mode information and a transmitting precoding weight vector based on the precoding information, and
indicating the transmission mode information to the receiving end.

30-34. (canceled)
